(19) United States
(12) Patent Application Publication
(10) Pub. No.: US 2021/0181612 A1
(43) Pub. Date: Jun. 17, 2021

(54) CEREMONIAL OCCASION VIDEO DISPLAY DEVICE AND CEREMONIAL OCCASION BUILDING

(71) Applicant: Tsukasa Shiga, Tokyo (JP)

(72) Inventor: Tsukasa Shiga, Tokyo (JP)

(21) Appl. No.: 16/769,896

(22) PCT Filed: Aug. 29, 2018
(86) PCT No.: PCT/JP2018/031873

§ 371 Date: Jun. 4, 2020

(30) Foreign Application Priority Data
Dec. 5, 2017 (JP) 2017-233597

(51) Int. Cl. G03B 21/12; A47G 33/00; G03B 21/14; G03B 21/54

(52) U.S. Cl. CPC G03B 21/12; G03B 21/54; G03B 21/14; A47G 33/00

(57) ABSTRACT

A ceremonial occasion video display device and a ceremonial occasion building capable of making more-ingeniously-planned innovative impressive production in a ceremony for a ceremonial occasion. A character projected onto a display region of a display member representing the shape of an opening book freely moves around on right and left pages for a while, and thereafter, starts such action that the character turns over a second page with the character holding a right end of the second page. On the display region after the second page has been turned over, other pictures as next pages are projected as if the character turns over the page of the book. Specifically, part of a third page is projected onto the display region at a position on the back side of the second page, and part of a fourth page is projected onto the region after the second page has been turned over.

### CROSS REFERENCE TO RELATED APPLICATIONS

This application is a National Stage Entry application of PCT Application No. PCT/JP2018/031873, filed Aug. 29, 2018, which claims the priority benefit of Japanese Patent Application No. JP 2017-233597, filed Dec. 5, 2017, the contents being incorporated herein by reference.

### BACKGROUND

The present disclosure relates to a ceremonial occasion video display device and a ceremonial occasion building, and particularly relates to a ceremonial occasion video display device and a ceremonial occasion building which can be utilized upon a ceremony for a ceremonial occasion.

A ceremonial occasion is a ceremony for reaching an important milestone in a life, and therefore, it has been demanded that the ceremonial occasion is impressive and memorable for people.

Typically, in, e.g., a wedding reception, a screen and a projector permanently installed at a wedding center have been utilized to display profile video of the bride and the groom, entertainment video, and end credits, thereby ingeniously planning production in the wedding reception for bringing excitement to the wedding reception (see, e.g., Japanese Patent Publication JP 2008-36097).

A ceremonial hall for the ceremonial occasion as described in Japanese Patent Publication JP 2008-36097 includes a ceremonial building body, the screen, the projector, and a stage. Moreover, the screen includes a front screen arranged at a front portion of the ceremonial hall, side screens arranged in parallel at the right and left of the front screen, and an upper screen portion provided on a ceiling. With the above-described configuration, a moving image can be projected onto the multiple screens in the ceremonial hall, and can be provided with a feeling of reality across a wide area in the ceremonial hall.

### SUMMARY

However, in such a ceremonial occasion, production utilizing the screen and the projector has been already broadly known. Thus, even when the moving image is provided across the wide area in the ceremonial hall as in Japanese Patent Publication JP 2008-36097, the feeling of reality is increased because the entirety of the ceremonial hall is surrounded by a large background, but it is hard to say that for the bride, the groom, and attendants, such production is innovative impressive production exceeding prediction and expectation.

Moreover, in many cases in the ceremonial occasion, there is much spare time, and the attendants need to kill time at, e.g., a waiting room or a lobby before and after the ceremony or the reception. During such time, video regarding, e.g., information on the bride and the groom is often played. However, it has been already obsolete, and for the attendants, could not be more than the mere way to kill time.

The present disclosure has been made in view of the above-described problem, and an object of the present disclosure is to provide a ceremonial occasion video display device and a ceremonial occasion building capable of making more-ingeniously-planned innovative impressive production in a ceremony for a ceremonial occasion.

According to a ceremonial occasion video display device of the present disclosure, the above-described problem is solved by a ceremonial occasion video display device used for a ceremonial occasion, the video display device including a display member having a display region for displaying video on a surface and a projection section configured to project the video onto the display region. The display member is in a shape representing an opening book state, and an opening page surface thereof forms the display region. When the video is switched from one moving image to the other moving image, the projection section projects connection video which is a moving image having a predetermined relationship with one moving image projected previously and which indicates contents for previewing the other moving image to be subsequently displayed.

Moreover, according to an embodiment of ceremonial occasion building, the above-described problem is solved by a ceremonial occasion building having a room used for a ceremonial occasion, the ceremonial occasion building including a display member having a display region for displaying video on a surface and a projection section configured to project the video onto the display region. The display member is in a shape representing an opening book state, and an opening page surface thereof forms the display region. When the video is switched from one moving image to the other moving image, the projection section projects connection video which is a moving image having a predetermined relationship with one moving image projected previously and which indicates contents for previewing the other moving image to be subsequently displayed.

As described above, the video is projected onto the display region of the display member representing the shape of an opening book, and when the video is switched from one moving image to the other moving image, the connection video which is the moving image having the predetermined relationship with one moving image projected previously and which indicates the contents for previewing the other moving image to be subsequently displayed is projected so that highly-entertaining production can be made to entertain a viewer.

Thus, in a ceremony for a ceremonial occasion, such as a wedding ceremony, more-ingeniously-planned innovative impressive video production can be made utilizing projection mapping. Particularly, the ceremonial occasion video display device is placed at an attendant's waiting room or a lobby so that an attendant can spend fulfilling time without killing time even during spare time.

Projection mapping described herein is the technique of displaying video as if the video is bonded to a surface of a three-dimensional object instead of a planar screen surface. The three-dimensional object as a screen for displaying the video can be targeted not only for a building but also for any object such as shoes, a table, a chair, a frame, a drawn picture, a human body, a room, a bag, a musical instrument, and a tree.

Particularly, in projection mapping for designing and producing a space itself which cannot be produced only with the planar screen surface, powerful video can be produced as if virtual and realistic worlds are mixed, and can captivate the attendant.

Moreover, the connection video is the moving image inserted upon switching from one moving image to the other moving image. Specifically, the connection video is the moving image having some kind of association with or continuity to one moving image or the other moving image and including the preview contents for imagining the other moving image to be displayed next one moving image.

In this case, the connection video may be for such production that one moving image is turned over from one end of one moving image and the other moving image is displayed on the display region after one moving image has been turned over.

As described above, the video is projected onto the display region of the display member representing the shape of the opening book, and when the video is switched from one moving image to the other moving image, the connection video which is for such production that one moving image is turned over from one end of one moving image and the other moving image is displayed on the display region after one moving image has been turned over is projected so that production can be, in combination with the shape of the display member, made as if a page of the book is turned over on the display region of the display member.

Thus, in the ceremony for the ceremonial occasion, such as the wedding ceremony, more-ingeniously-planned innovative impressive video production can be made utilizing projection mapping.

In this case, the video display device may further include a speaker configured to play predetermined music or a sound effect. The projection section may project the connection video in association with the music or the sound effect.

As described above, the video and the music or the sound effect are associated with each other, and for example, the sound effect is played at the timing of projecting the connection video as if the page is turned over. Thus, production with a more feeling of turning over the page of the book can be made.

Thus, in the ceremony for the ceremonial occasion, such as the wedding ceremony, more-ingeniously-planned innovative impressive video production can be made utilizing projection mapping.

In this case, the video may include a combination of pictures of memories of the bride and the groom or the deceased.

As described above, the video to be projected includes the combination of the pictures of the memories of the bride and the groom or the deceased, and therefore, production can be made as if a page of an album of the bride and the groom or the deceased is turned over.

Thus, in the ceremony for the ceremonial occasion, such as the wedding ceremony, more-ingeniously-planned innovative impressive video production can be made utilizing projection mapping.

According to the ceremonial occasion video display device and the ceremonial occasion building of the present disclosure, more-ingeniously-planned innovative impressive production can be made utilizing, e.g., projection mapping in a ceremony for a ceremonial occasion.

### BRIEF DESCRIPTION OF DRAWINGS

Various embodiments are illustrated in the drawings, in which:

FIG. 1 is a front view of a ceremonial occasion video display device according to an embodiment;

FIG. 2 is a schematic view for describing the ceremonial occasion video display device;

FIG. 3 is a view for describing one example of a state in which video production on a display member of the ceremonial occasion video display device by projection mapping is executed;

FIG. 4 is a view for describing one example of the state in which video production on the display member of the ceremonial occasion video display device is executed;

FIG. 5 is a view for describing one example of the state in which video production on the display member of the ceremonial occasion video display device is executed; and

FIG. 6 is a view for describing one example of the state in which video production on the display member of the ceremonial occasion video display device is executed.

### DETAILED DESCRIPTION

Hereinafter, embodiments are described with reference to the figures.

An embodiment relates to the technique of a ceremonial occasion video display device including a display member having a display region for displaying video on a surface and representing the shape of an opening book and a projector configured to project the video onto the display region of the display member. Upon projection of the video onto the display member, when the video is switched from one moving image to the other moving image, video which is a moving image having a predetermined relationship with one moving image projected previously and which indicates contents for previewing the other moving image to be subsequently displayed, i.e., connection video for performing such production that one moving image is turned over from one end of one moving image and the other moving image is displayed on the display region after one moving image has been turned over, is projected to perform production as if a page of a book is turned over on the display region of the display member, and relates to the technique of a ceremonial occasion building including the ceremonial occasion video display device.

Note that projection mapping is the technique of displaying video as if the video is bonded to a surface of a three-dimensional object such as a building, an object, or a space, and is also called, e.g., 3D mapping, video mapping, or architectural mapping.

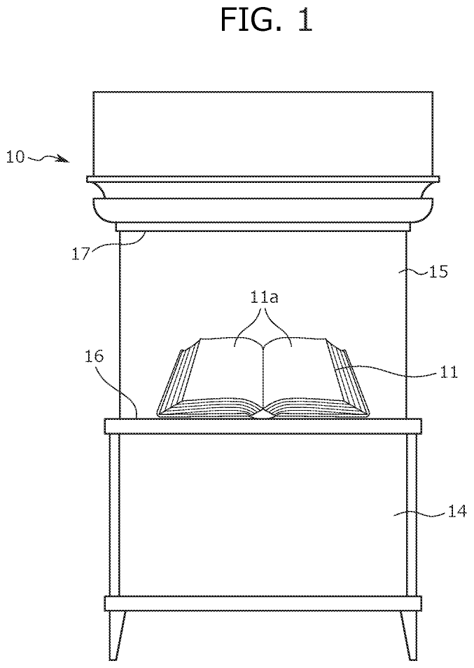

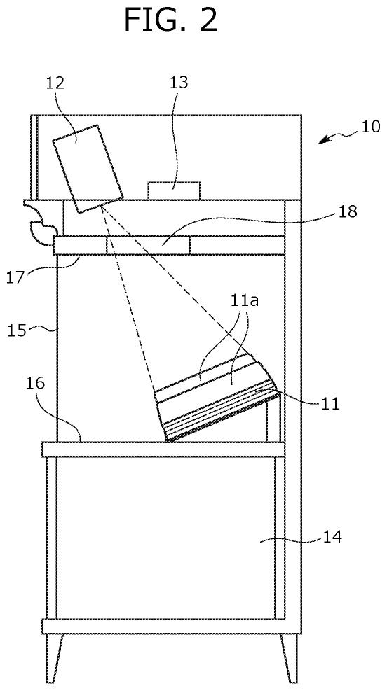

FIG. 1 is a front view of a ceremonial occasion video display device 10. FIG. 2 is a schematic illustrative view of the ceremonial occasion video display device 10 from the side.

The ceremonial occasion video display device 10 is, for example, placed at a waiting room or a lobby particularly in a building such as a hotel or a wedding house utilized for a wedding ceremony etc.

Note that the building in which the ceremonial occasion video display device 10 is placed, such as the hotel or the wedding house, is equivalent to a ceremonial occasion building.

As illustrated in FIGS. 1 and 2, the ceremonial occasion video display device 10 mainly includes a display member 11 representing the shape of an opening book, a projector 12 configured to project video onto the display member 11, a speaker 13 configured to play predetermined music or a sound effect, a main body 14 housing the display member 11, the projector 12, and the speaker 13 in an internal space, and a transparent glass plate 15 surrounding such that the display member 11 inside the main body 14 is visible from the outside of the main body 14.

The display member 11 is a three-dimensional object representing the shape of the opening book, and a portion forming an upper surface, i.e., an opening page portion, forms a display region 11a functioning as a screen for displaying the video. As long as the video can be projected onto the display region 11a, the detailed shape, size, and material of the display region 11a are not limited. In the present embodiment, the display region 11a is formed slightly curved for providing the texture of the opening book.

The display member 11 is placed on a floor board 16 included in the later-described main body 14. In this state, the display member 11 is placed with a slightly-forward slope such that the display region 11a is easily visible from the front of the ceremonial occasion video display device 10.

The video is projected onto the display region 11a of the display member 11 having the above-described configuration by the later-described projector 12, and in this manner, an atmosphere can be created as if the opening book is viewed.

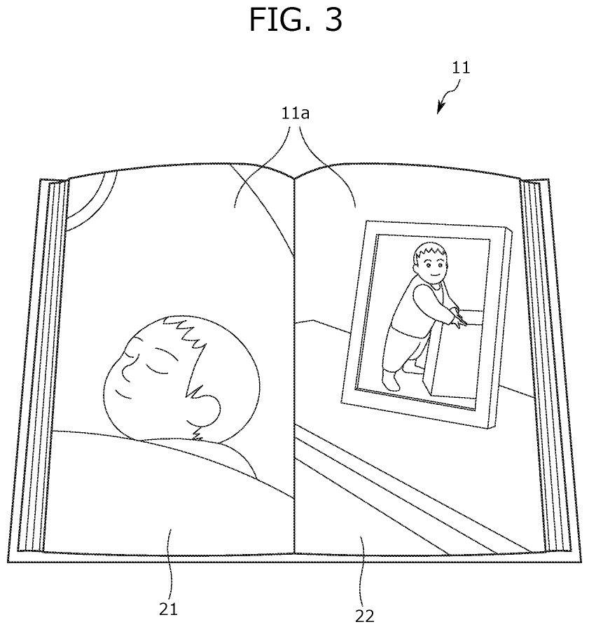

The projector 12 is a projector configured to project the video corresponding to the display region 11a onto the display region 11a of the display member 11 as in FIGS. 3 to 6 described below. The video to be projected may be a moving image or a still image.

The projector 12 is, in a space above the main body 14, placed at a position which is not visible from the outside. In the main body 14, a space in which the display member 11 is placed and a space in which the projector 12 is placed are partitioned by a ceiling board 17. At a spot exposed to the video projected by the projector 12, an opening 18 is formed at the ceiling board 17 so that the video can pass through the opening 18. Note that, e.g., a transparent glass plate may be placed in the opening 18.

The phrase of “project the video corresponding to the display region 11a” as described herein includes a meaning that a material (an object) as the video is projected such that the material is bonded to a surface region of the three-dimensional object, i.e., projection mapping is produced.

Note that any type of projector 12 can be employed without limitations as long as the projector 12 is a projector capable of producing projection mapping. A light source of the projector 12 may be any light sources such as an LED light source. Moreover, in the present embodiment, the single projector 12 is provided, but multiple projectors 12 can be placed.

The speaker 13 is acoustic equipment configured to play the predetermined music or the sound effect in association with the video projected onto the display region 11a.

In an embodiment, the speaker 13 is, as in the projector 12, placed at a position which is not visible from the outside in the space above the main body 14, but is not limited to such a position. For example, the speaker 13 can be placed at, e.g., the front or side of the main body 14. Moreover, multiple speakers 13 can be placed.

The main body 14 is a general showcase in which goods such as the display member 11 can be displayed in an internal space. The main body 14 has at least the floor board 16 on which the display member 11 is mounted and the ceiling board 17 configured to divide the space in which the display member 11 is placed and the space in which the projector 12 is placed from each other. At the ceiling board 17, the opening 18 as a passage for the video projected from the projector 12 is formed. A not-shown decoration with a feeling of depth is added to an outer surface of the main body 14.

Moreover, in an embodiment, the periphery of the display member 11 is surrounded by the transparent glass plate 15 such that, e.g., contact of an attendant's hand with the display member 11 is prevented. Thus, an attendant can view, through the glass plate 15, the display member 11 housed inside the main body 14. Note that the glass plate 15 is not necessarily provided.

Next, production contents when the video utilizing projection mapping is projected onto the display region 11a is described based on FIGS. 3 to 6.

FIGS. 3 to 6 are views for describing one example of a state in which video production on the display region 11a of the display member 11 by projection mapping is executed by the projector 12, and the video transitions in the order of FIGS. 3, 4, 5, and 6.

In FIG. 3, pictures of memories of the bride and the groom are, by the projector 12, projected onto the display region 11a of the display member 11 representing the opening book. Specifically, a picture of a sleeping face of the groom when the groom was a baby is displayed on a left page of the opening book (hereinafter referred to as a “first page 21”). Moreover, a picture of the groom when the groom was a child is displayed on a right page of the opening book (hereinafter referred to as a “second page 22”).

Note that as data of the pictures projected herein, data provided in advance from the bride, the groom, and people involved is utilized with the data being stored in a not-shown storage section.

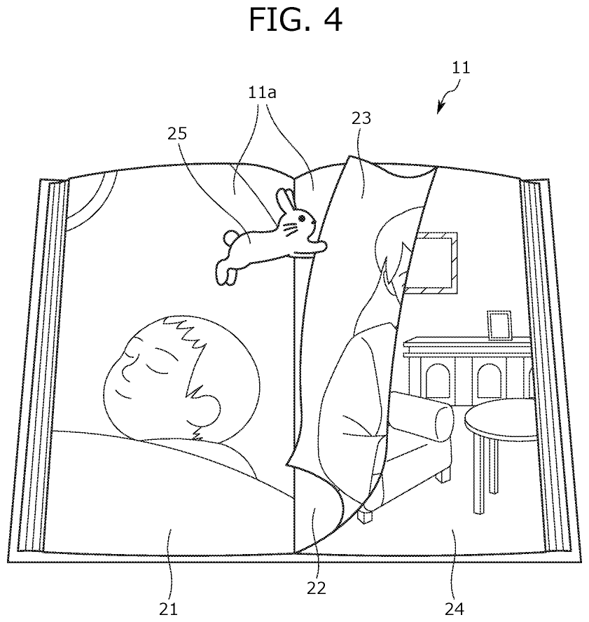

As illustrated in FIG. 4, a character 25 is projected and appears on the display region 11a after a lapse of predetermined time from projection of the video illustrated in FIG. 3. The character 25 projected onto the display region 11a freely moves around on the right and left pages for a while (not shown), and thereafter, starts such action that the character 25 turns over the second page 22 with the character 25 holding a right end of the second page 22.

On the display region 11a after the second page 22 has been turned over, other pictures as next pages are projected as if the character 25 turns over the page of the book. Specifically, part of a third page 23 is projected onto the display region 11a at a position on the back side of the second page 22, and part of a fourth page 24 is projected onto a region after the second page 22 has been turned over.

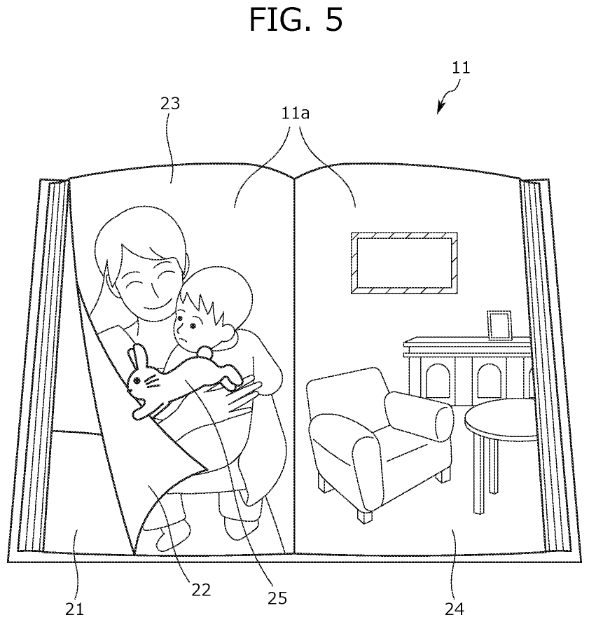

As illustrated in FIG. 5, when the character 25 starts such action that the character 25 turns over the second page 22, the regions of the first page 21 and the second page 22 are gradually narrowed over time, and in proportion to such narrowing, the regions of the third page 23 and the fourth page 24 are subsequently gradually broadened. At this point, the video projected onto the display region 11a changes as if the page of the book is turned over. Eventually, the character 25 having taken action for turning over the second page 22 performs such action that the character 25 closes the first page 21 and the second page 22.

Note that the video as illustrated in FIGS. 4 to 5 is equivalent to connection video.

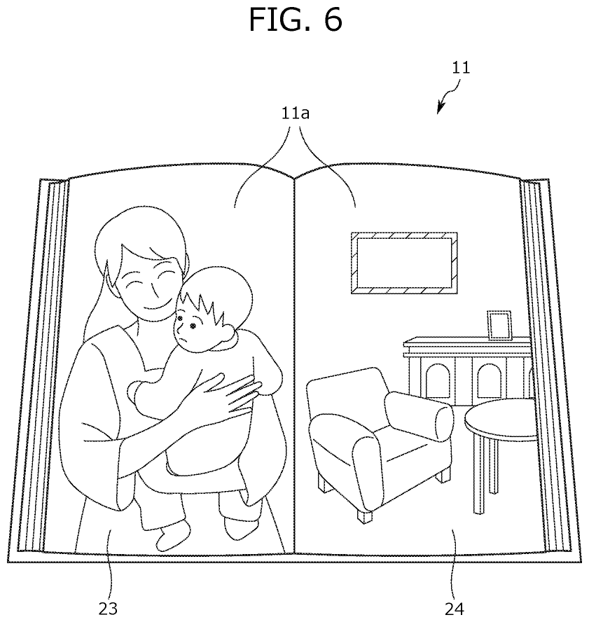

As illustrated in FIG. 6, when the character 25 completely finishes turning over the page, the character 25 is temporarily hidden, and a picture of the groom held in mother's arms is displayed on the third page 23 as the left page of the opening book. Moreover, a picture of a memorable room in which the groom spent his childhood is displayed on the fourth page 24 as the right page of the opening book.

Thereafter, the page is turned over one after another, and over time, is switched to a new page on which a different picture is displayed.

Moreover, music as BGM matching the atmosphere is, as video production by projection mapping, played from the speaker 13 equipped in the ceremonial occasion video display device 10. Further, upon video production as illustrated in FIGS. 4 to 5, i.e., the video showing that the page is being turned over, the sound effect is accordingly played as if the page is turned over.

With this configuration, upon use of the ceremonial occasion video display device 10, when the attendant views the pictures projected on the display member 11 (the display region 11a) in the ceremonial occasion video display device 10, the attendant has, in combination with the shape of the display member 11 representing the opening book, a feeling as if the attendant opens and views an album of the memories of the bride and the groom.

Moreover, by such production that the connection video as illustrated in FIGS. 4 to 5 is inserted, a state in which the attendant turns over the page to view the album of the memories of the bride and the groom can be faithfully reproduced for the attendant.

In the present embodiment, by video production as described above, more-ingeniously-planned innovative impressive production can be made by projection mapping in the wedding ceremony. Particularly, the ceremonial occasion video display device 10 is placed at, e.g., the waiting room or the lobby in a wedding center, and therefore, the attendant can spend fulfilling time without killing time even during spare time before and after the wedding ceremony or reception.

A ceremonial occasion video display device and the ceremonial occasion building according to an embodiment have been mainly described.

Note that the above-described embodiment is merely one example for the sake of easy understanding, and is not intended to be limiting. For example, in the above-described embodiment, utilization at the wedding ceremony has been described. However, when video production by projection mapping is executed using pictures of memories of the deceased instead of the pictures of the memories of the bride and the groom, the present disclosure can be similarly applied to, e.g., a funeral.

Moreover, changes and modifications can be made to the described embodiments without departing from the gist of the present disclosure, and needless to say, the present disclosure includes equivalents thereof.

### TABLE OF REFERENCE NUMERALS

10: ceremonial occasion video display device
11: display member
   11a: display region
12: projector
13: speaker
14: main body
15: glass plate
16: floor board
17: ceiling board
18: opening
21: first page
22: second page
23: third page
24: fourth page
25: character

1. A ceremonial occasion video display device used for a ceremonial occasion, comprising:
a display member including a display region for displaying video on a surface; and
a projection section configured to project the video onto the display region,
wherein the display member is in a shape representing an opening book state, and an opening page surface thereof forms the display region, and
wherein when the video is switched from one moving image to the other moving image, the projection section projects connection video which is a moving image having a predetermined relationship with the one moving image projected previously and which indicates a content for previewing the other moving image to be subsequently displayed.

2. The ceremonial occasion video display device according to claim 1,
wherein the connection video is for such production that the one moving image is turned over from one end of the one moving image and the other moving image is displayed on the display region after the one moving image has been turned over.

3. The ceremonial occasion video display device according to claim 1, further comprising:
a speaker configured to play predetermined music or a sound effect,
wherein the projection section projects the connection video in association with the music or the sound effect.

4. The ceremonial occasion video display device according to claim 1,
wherein the video includes a combination of pictures of memories of a bride and a groom or a deceased.

5. A ceremonial occasion building having a room used for a ceremonial occasion, comprising:
a display member including a display region for displaying video on a surface; and
a projection section configured to project the video onto the display region,
wherein the display member is in a shape representing an opening book state, and an opening page surface thereof forms the display region, and
wherein when the video is switched from one moving image to the other moving image, the projection section projects connection video which is a moving image having a predetermined relationship with the one moving image projected previously and which indicates a content for previewing the other moving image to be subsequently displayed.
